(19) United States
(12) Patent Application Publication
(10) Pub. No.: US 2005/0155083 A1
(43) Pub. Date: Jul. 14, 2005

(54) Network game system having game channels and network game method thereof

(76) Inventors: Sang-seok Oh, Suwon-si (KR); Hong-jun Ku, Hwaseong-si (KR)

Correspondence Address: STANZIONE & KIM, LLP, 1740 N STREET, N.W., FIRST FLOOR, WASHINGTON, DC, 20036, US

(21) Appl. No.: 11/031,070

(22) Filed: Jan. 10, 2005

(30) Foreign Application Priority Data
Jan. 14, 2004 (KR) 2004-2703

(51) Int. Cl. H04N 7/173; G06F 19/00; G06F 17/00; A63F 13/00; A63F 9/24; H04N 7/16

(52) U.S. Cl. 725/133; 725/141; 725/153; 463/40

(57) ABSTRACT

Disclosed is a network game system having allocated game channels and network game method therefor. The network game system comprises a service provider to support a variety network games, and providing additional game information corresponding to the network game information; a broadcast station to allocate at least one or more game channels, and to transmit the additional game information corresponding to the network game information provided in real time from the service provider; and at least one or more digital broadcast receivers to receive the additional game information transmitted from the game channels, and to directly receive and transmit from and to the service provider substantial game play information corresponding to the network game information running based on the received additional game information. Accordingly, the network game system can minimize the amount of data received through the communication modules such as a modem and a network card for digital broadcast receivers, to thereby enhance a network game speed.

### CROSS-REFERENCE TO RELATED APPLICATIONS

This application claims benefit under 35 U.S.C. § 119 from Korean Patent Application No. 2004-2703, filed on Jan. 14, 2004, the disclosure of which is incorporated herein in its entirety and by reference.

### BACKGROUND OF THE INVENTION

1. Field of the Invention

The present general inventive concept relates to a digital broadcast receiver, and more particularly to a network game system using digital broadcast receivers and a network game method thereof.

2. Description of the Related Art

FIG. 1 is a schematic representation of a network game system using existing settop boxes. As shown in FIG. 1, the network game system includes a service provider 110 to provide game services and a plurality of settop boxes (STB1, STB2, . . . , and STBn) 131, 133, . . . , and 135, each having a modem and a network card to connect the system to the service provider 110.

The plurality of settop boxes 131, 133, . . . , and 135 each receive and transmit, through the modem and the network card, data to run a variety of games, and enable users to play network games by use of the received and transmitted data.

A user of the first settop box (STB1) 131 is connected to the service provider 110 through the modem and network card that are mounted in the first settop box 131, and the first settop box 131 receives and transmits game data from and to the service provider 110 through the modem and network card.

In a multi-user game, the first settop box 131 displays information on the game room and information on the connected players on an initial game screen. The above information is received from the service provider 110 through the modem and the network card. Next, as a player selects a certain game room on the initial game screen, a network game starts. A game application runs in the first settop box 131, and the first settop box 131 receives and transmits game play information corresponding to the network game from and to the service provider 110 through the modem and the network card, so the network game runs.

The conventional network game system as described above has problems as described below. First, the information on the game room and players changes in real time, and in order to receive data through the modem and network card, players have to wait for a considerably long period of time due to high amounts of data, which causes inconvenience to the players.

Second, data of commercial advertisements, other background images, and so on are continuously transmitted and displayed on the initial game screen, so the modem and the network card have to process a considerable amount of data.

Therefore, the existing network game systems have the disadvantages of low game speed and player inconvenience.

### SUMMARY OF THE INVENTION

The present general inventive concept provides a network game system having one or more digital broadcast receivers and a network game method wherein basic information to run network games is received and transmitted through a modem and a network card and additional information is received through a broadcast channel.

Additional aspects and advantages of the present general inventive concept will be set forth in part in the description which follows and, in part, will be obvious from the description, or may be learned by practice of the general inventive concept.

The forgoing and/or other aspects and advantages of the present general inventive concept are substantially realized by providing a network game system comprising a service provider to support a variety of network games, and providing additional game information corresponding to network game information, a broadcast station to allocate at least one or more game channels, and to transmit the additional game information corresponding to the network games provided in real time from the service provider, and at least one or more digital broadcast receivers to receive the additional game information transmitted from the game channels, and to directly receive and transmit from and to the service provider substantial game play information corresponding to the network game information running based on the received additional game information, wherein the service provider, broadcast station, and digital broadcast receivers are interconnected in a network.

The additional game information corresponding to the network game information may include information on game rooms and information on game players at various locations, and the additional game information may further include commercial advertisement information.

The broadcast station may allocate at least one or more game channels, and transmits at least one or more pieces of additional game information corresponding to at least one or more network games.

The digital broadcast receivers may each include a tuner to receive the additional game information transmitted in real time to the game channels, a storage part to store game applications to run the network games, a communication part to receive and transmit from and to the service provider the substantial game play information corresponding to the network game information running based on the received additional game information, and a controller to control the tuner to receive the additional game information if the game channels are selected, and to control the communication part to communicate with the service provider the substantial game play information corresponding to the running network games.

The network game system may further comprise a display part to display as a main screen an initial game screen corresponding to the additional game information received in real time from the tuner, wherein the controller runs the game applications and displays as a secondary screen a game screen corresponding to the substantial game play information that is received and transmitted from and to the communication part.

The forgoing and/or other aspects and advantages of the present general inventive concept may also be substantially realized by providing a network game method using a network game system having a service provider, a broadcast station and digital broadcast receivers, comprising supporting a variety of network games, and providing to a broadcast station additional game information corresponding to the network games, processing to a broadcast signal the additional game information corresponding to the network games provided in real time from a service provider, and transmitting the broadcast signal to allocated game channels, and receiving by at least one or more digital broadcast receivers the additional game information transmitted from the game channels, and directly receiving and transmitting from and to the service provider substantial game play information corresponding to the network games running based on the received additional game information.

In the operation of receiving by at least one or more digital broadcast receivers the additional game information transmitted from the game channels, and directly receiving and transmitting from and to the service provider substantial game play information, a first digital broadcast receiver may include operations of receiving through a tuner the additional game information that is transmitted in real time, if the game channels are selected, selecting one of a plurality of game rooms based on the received additional game information, transmitting information on the selected game room to the service provider through a communication part, and running the network games, and directly receiving and transmitting the substantial game play information corresponding to the network games from and to the service provider through the communication part, and running the games with a second broadcast receiver connected to the selected location.

The operation of receiving through a tuner the additional game information that is transmitted through real time may comprise displaying as a main screen an initial game screen corresponding to the additional game information received in real time from the tuner.

The operation of directly receiving and transmitting the substantial game play information may comprise displaying as a secondary screen a game screen corresponding to the game play information which is received and transmitted from and to the communication part.

Accordingly, the present general inventive concept can enhance network game speed and minimize the amount of data received through communication modules such as a modem and a network card for digital broadcast receivers.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic representation of a network game system using existing settop boxes;

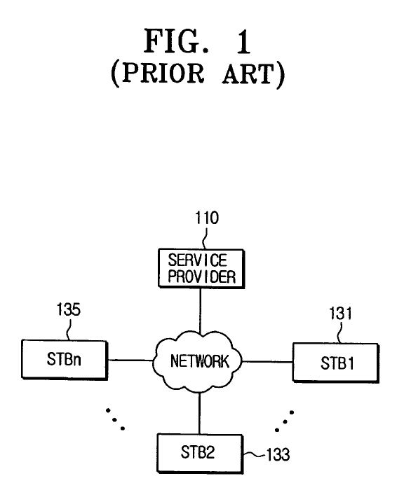

FIG. 2 is a schematic representation of a network game system using digital broadcast receivers according to an embodiment of the present general inventive concept;

FIG. 3 is a schematic representation of a digital broadcast receiver according to an embodiment of the present general inventive concept;

FIG. 4 is a schematic representation of a network game method of a network game system according to an embodiment of the present general inventive concept; and

FIG. 5 is a schematic representation of an exemplary game screen displayed on a display part in the network game method of FIG. 4, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

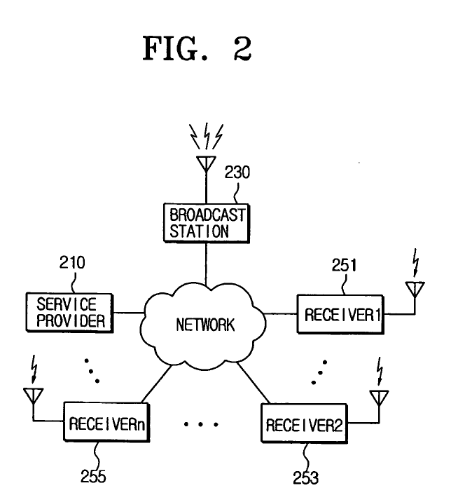

FIG. 2 is a schematic representation of a network game system according to an embodiment of the present general inventive concept. As shown in FIG. 2, a network game system includes a service provider 210 to provide a variety of game services, a broadcast station 230 to allocate a certain number of broadcast channels and to transmit additional game information on network games provided from the service provider 210, and at least one or more digital broadcast receivers 251, 253, . . . , and 255 to directly communicate game play information with the service provider 210 through communication modules to run the substantial network games, and to receive additional game information through broadcast channels.

The service provider 210 receives and transmits diverse game service information from and to devices connected in a network. The service provider 210 transmits to the broadcast station 230 a variety of additional game information to run various network games.

The broadcast station 230 allocates at least one or more broadcast channels under agreement between the service provider 210 and the broadcast station 230, and transmits over the broadcast channels additional game information to run at least one or more network games. Throughout this disclosure, the term ‘additional game information’ refers to information on a game room for a corresponding network game, information on players in the game room, and information on commercial advertisement.

The broadcast station 230 allocates at least one or more broadcast channels to transmit the additional game information as described above, and to transmit through the allocated broadcast channels the additional game information processed into a broadcast signal. Hereinafter, a broadcast channel transmitting the additional game information is referred to as a ‘game channel’.

The plurality of digital broadcast receivers 251, 253, . . . , and 255 each receive and display in real time the additional game information in a game channel tuned by a respective tuner, and communicate substantial game play information with the service provider 210 through communication modules as the network games run, which can prevent a network game speed from slowing down due to the transmission of the additional game information requiring lots of data, and remove player inconvenience.

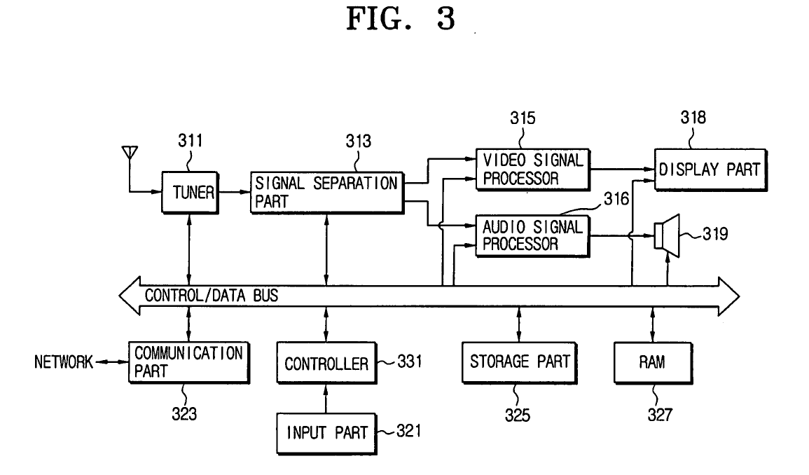

FIG. 3 is a schematic representation of a digital broadcast receiver according to an embodiment of the present general inventive concept. Referring to FIG. 3, a digital broadcast receiver has a tuner 311, a signal separation part 313, a video signal processor 315, a display part 318, an audio signal processor 316, a speaker 319, an input part 321, a communication part 323, a storage part 325, a random access memory (RAM) 327, and a controller 331.

The tuner 311 receives a broadcast signal in a selected channel. For example, if a certain game channel is selected, the tuner 311 receives additional game information which is processed into a broadcast signal and transmitted in the game channel.

The signal separation part 313 separates the broadcast signal of the tuned channel into a video signal and an audio signal.

The video signal processor 315 decodes the video signal in a predetermined manner, and processes the decoded video signal to be displayed on the display part 318 as an output. The display part 318 is a device to externally display the video signal, such as a television, a liquid crystal display, a plasma display panel, etc.

The audio signal processor 316 decodes an audio signal in a predetermined manner, and processes the decoded audio signal to be externally outputted through the speaker 319.

The storage part 325 stores a variety of game applications to run various network games, and has basic programs to directly control other hardware in the receiver.

The RAM 327 is a temporary storage place. For example, when a certain game channel is tuned in and a game runs, the controller 331 temporarily stores in the RAM 327 a certain game application stored in the storage part 325 and runs the application. Therefore, the screen for the game is activated and displayed as a secondary screen with respect to the screen for the tuned game channel.

The input part 321 is a device to input players' commands, and includes an operation panel (not shown) having a plurality of operation buttons and a sensor (not shown) to receive operation commands transmitted from a remote controller (not shown).

The communication part 323 is a communication module such as a modem or a network card, and is connected to at least one external communication network to communicate data. If a game runs on the screen for a certain game channel, the communication part 323 directly communicates substantial game play information with a service provider 210.

The controller 331 controls the overall operations of the receiver.

For example, if a game channel is turned to in accordance with a user's operation command, the display part 318 displays on the initial game screen additional game information transmitted to the tuned game channel. Next, the player selects one of the game rooms to which he wants to connect to based on the displayed additional game information, such as information on the game rooms and on players. The controller 331 transmits the selected location game room through the communication part 323 to the service provider, by which the service provider supports the network game among players in the selected game room.

The controller 331 runs a stored game application to display a game state among the players of the room based on the substantial game play information that is directly received and transmitted from and to the service provider. Further, the controller 331 displays in real time on the display part 318 the updated additional game information received from the game channel tuned by the tuner 311.

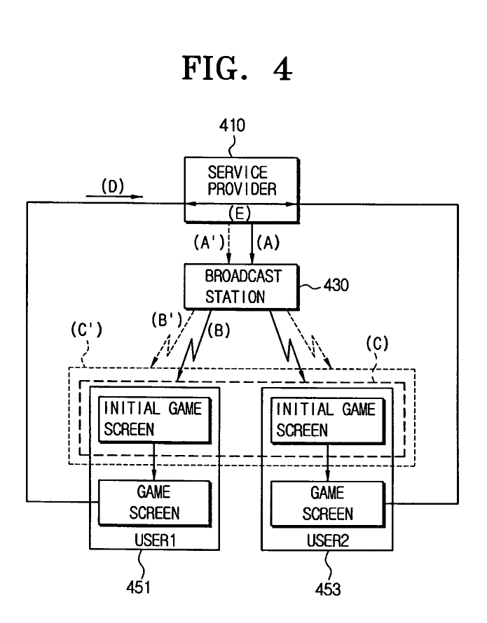

Hereinafter, a network game method for a network game system according to an embodiment of the present general inventive concept will be described in detail with reference to FIG. 4.

A service provider 410 transmits additional game information on a game to a broadcast station 430 in a network (Operation A). The additional game information includes information on a plurality of game rooms currently available and information on players of each room, in addition to commercial advertisements. The additional game information is transmitted to the broadcast station 430 in real time.

The broadcast station 430 processes into a broadcast signal the additional game information provided in real time from the service provider 410, and transmits the broadcast signal through a certain game channel (Operation B).

The digital broadcast receivers 451 and 453 each enable players to tune to a certain game channel to enjoy a network game (Operation C).

For example, a first player selects a certain game channel through a remote controller (not shown) as an input device of the first digital broadcast receiver 451, and displays on the display part additional game information on a game transmitted to the selected game channel.

The additional game information displayed on the display part is displayed on the initial game screen, the first player selects one of the available game rooms based on the additional game information displayed on the display part, and runs a network game. Further, the first player can select a game room by use of direction buttons and numeral buttons provided on the remote controller (not shown).

After the selection of a game room, the digital broadcast receiver 451 transmits information on the selected game room to the service provider 410 through a modem and a network card that are communication modules (Operation D).

Next, the service provider 410 provides services enabling a second player in the game room to run the network game through the second digital broadcast receiver 453 based on the game room information transmitted from the first digital broadcast receiver 451 (Operation E).

In Operation E, the information transmitted to the service provider 410 is substantial game play information transmitted through the communication modules of the first and second digital broadcast receivers 451 and 453, and the service provider 410 sends to the counterpart player the substantial game play information transmitted to the service provider 410, so as to support the network game.

Further, the service provider 410 transmits to the broadcast station 430 the information on the game rooms and the players of the room, wherein the information can be changed in real time (Operation A′), and the broadcast station 430 processes into a broadcast signal the additional game information that is being transmitted in real time, and transmits the broadcast signal to a corresponding game channel (Operation B′).

Next, the first and second digital broadcast receivers 451 and 453 each display on the initial game screen the additional game information that is updated and transmitted in real time to the game channel (Operation C′).

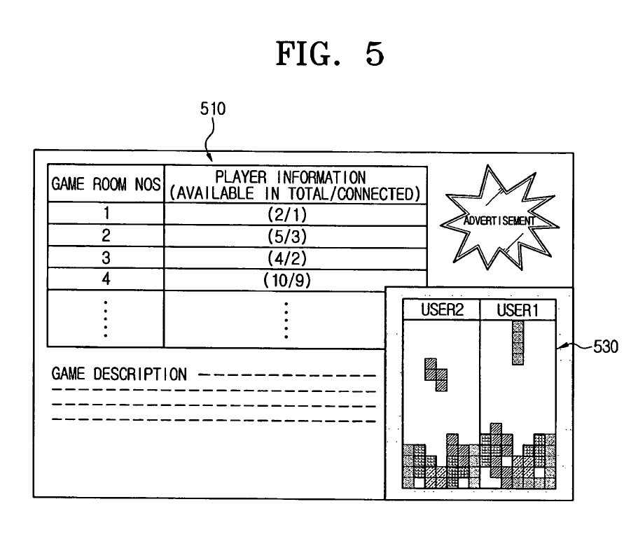

FIG. 5 is a schematic representation of an exemplary screen displayed on a display part based on the network game method according to an embodiment of the present general inventive concept. The additional game information (including information on the game rooms, information on the players of the same game room, and advertisements), which is transmitted through a game channel, is displayed on the display part in the initial game screen 510. Thereafter, the main screen of the game 530 is displayed as a secondary screen with respect to the initial game screen 510. Therefore, the additional game information, which is updated in real time during the running of the game on the game screen 530, is received through the game channel, and displayed on the initial game screen 510.

Accordingly, only the substantial game play information is directly received and transmitted from and to a service provider through the communication modules such as a modem and a network card, and the other additional game information is received in real time through a game channel, so that the game speed can be prevented from slowing down due to a sudden increase of data volume in the communication modules.

The present general inventive concept can minimize the amount of data received through communication modules such as a modem and a network card for digital broadcast receivers, to thereby enhance network game speed.

Further, the present general inventive concept can enhance game speed by receiving additional game information corresponding to substantial game play information through a broadcast channel by a tuner of a digital broadcast receiver, and also increase profits of service providers by transmitting commercial advertisement information as additional information.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A network game system, comprising:
a service provider to support a plurality of network games, and to provide additional game information corresponding to network game information;
a broadcast station to allocate one or more game channels, and to transmit through the one or more game channels the additional game information corresponding to the network game information provided in real time from the service provider; and
at least one digital broadcast receiver to receive the additional game information transmitted through the game channels, and to directly receive and transmit from and to the service provider substantial game play information corresponding to the network game information running based on the received additional game information, wherein the service provider, broadcast station, and digital broadcast receivers are interconnected in a network.

2. The network game system as claimed in claim 1, wherein the additional game information corresponding to the network game information includes at least one member of a group consisting of information on game rooms and information on game players in a game room.

3. The network game system as claimed in claim 2, wherein the additional game information further comprises commercial advertisement information.

4. The network game system as claimed in claim 1, wherein the broadcast station transmits the additional game information corresponding to one or more of the plurality of network games.

5. The network game system as claimed in claim 1, wherein the at least one digital broadcast receiver comprises:
a tuner to receive the additional game information transmitted in real time through at least one of the game channels;
a storage part to store game applications to run the network games;
a communication part to receive and transmit from and to the service provider the substantial game play information running based on the received additional game information; and
a controller to control the tuner to receive the additional game information if the at least one game channel is selected, and to control the communication part to communicate with the service provider the substantial game play information corresponding to the running network games.

6. The network game system as claimed in claim 5, further comprising a display part to display as a main screen an initial game screen corresponding to the additional game information received in real time from the tuner, wherein the controller runs the game applications and displays as a secondary screen a game screen corresponding to the substantial game play information that is received and transmitted from and to the communication part.

7. The network game system as claimed in claim 5, wherein the communication part comprises at least one member of a group consisting of a modem and a network card.

8. A network game system comprising:
a service provider to transmit additional game information corresponding to network games;
a broadcast station to receive the transmitted additional game information and process the additional game information into a broadcast signal and to broadcast the broadcast signal through at least one game channel; and
a plurality of broadcast receivers each capable of tuning to the at least one game channel to receive the broadcast signal and to play the corresponding network game.

9. A digital broadcast receiver comprising:
a tuner to receive over a game channel a broadcast signal comprising additional game information corresponding to a network game;
an input part to receive input to be processed into substantial game play information;
a controller to process the input into the substantial game play information; and
a communication part to communicate to a service provider the substantial game play information.

10. The digital broadcast receiver as claimed in claim 9, further comprising:
a storage part to store a game application of the network game.

11. The digital broadcast receiver as claimed in claim 9, wherein the additional game information comprises at least one member of a group consisting of information on game rooms, information on game players in a game room, and commercial advertisement information.

12. The digital broadcast receiver as claimed in claim 9, further comprising:
a video signal processor to process the broadcast signal into a video signal to be displayed on a display part,
wherein the video signal causes the display part to display as a main screen an initial game screen corresponding to the additional game information received in real time from the tuner, and wherein the controller runs the game application and controls the display part to display as a secondary screen a game screen corresponding to the substantial game play information.

13. The digital broadcast receiver as claimed in claim 9, wherein the communication part comprises at least one member of a group consisting of a modem and a network card.

14. A network game method using a network game system including a service provider, a broadcast station and one or more digital broadcast receivers, the method comprising:
supporting a plurality of network games, and providing to a broadcast station additional game information corresponding to the network games;
processing to a broadcast signal the additional game information corresponding to the network games provided in real time from a service provider, and transmitting the broadcast signal to one or more allocated game channels; and
receiving by one or more digital broadcast receivers the additional game information transmitted through the game channels, and directly receiving and transmitting from and to the service provider substantial game play information corresponding to the network games running based on the received additional game information, wherein the service provider, broadcast station, and one or more digital broadcast receivers are interconnected in a network.

15. The network game method as claimed in claim 14, wherein the additional game information corresponding to network game information includes at least one member of a group consisting of information on game rooms and information on game players in a game room.

16. The network game method as claimed in claim 15, wherein the additional game information further includes commercial advertisement information.

17. The network game method as claimed in claim 14, wherein the broadcast station allocates one or more game channels, and transmits the additional game information corresponding to one or more of the plurality of network games.

18. The network game method as claimed in claim 14, wherein, in the operation of receiving by one or more digital broadcast receivers the additional game information transmitted through the game channels, and directly receiving and transmitting from and to the service provider substantial game play information corresponding to the network games, a first digital broadcast receiver comprises operations of:
receiving through a tuner the additional game information that is transmitted in real time, if at least one of the game channels is selected;
selecting a game room based on the received additional game information;
transmitting information on the selected game room to the service provider through a communication part;
running at least one of the network games;
directly receiving and transmitting the substantial game play information corresponding to the network games from and to the service provider through the communication part; and
running the at least one network games with a second broadcast receiver connected to a selected location.

19. The network game method as claimed in claim 18, wherein the operation of receiving through a tuner the additional game information that is transmitted in real time further comprises displaying as a main screen an initial game screen corresponding to the additional game information received in real time from the tuner.

20. The network game method as claimed in claim 18, wherein the directly receiving and transmitting operation further comprises displaying as a secondary screen a game screen corresponding to the substantial game play information that is received and transmitted from and to the communication part.

21. The network game method as claimed in claim 18, wherein the communication part comprises at least one member of a group consisting of a modem and a network card.

22. A method of supporting network games between a plurality of users, the method comprising:
receiving substantial game play information from at least one user over a network, the substantial game play information corresponding to a network game;
processing to a signal additional game information corresponding to the network game; and
communicating the signal through at least one game channel to the at least one user.

23. The method as claimed in claim 22, wherein the transmitting operation comprises:
transmitting the signal to a broadcast station.

24. The method as claimed in claim 22, wherein the additional game information comprises at least one member of a group consisting of information on game rooms, information on game players in a game room, and commercial advertisement information.

25. A method of supporting network games between a plurality of users, the method comprising:
receiving a signal comprising additional game information corresponding to a network game;
allocating at least one game channel to broadcast the signal;
broadcasting the signal to the plurality of users.

26. The method as claimed in claim 25, wherein the additional game information comprises at least one member of a group consisting of information on game rooms, information on game players in a game room, and commercial advertisement information.
